(19) United States
(12) Patent Application Publication
(10) Pub. No.: US 2023/0111442 A1
(43) Pub. Date: Apr. 13, 2023

(54) APPARATUS AND METHOD FOR UPDATING CONTROLLER FOR MOBILITY DEVICE

(71) Applicants: HYUNDAI MOTOR COMPANY, Seoul (KR); Kia Corporation, Seoul (KR)

(72) Inventor: Tae Ho LEE, Seoul (KR)

(73) Assignees: HYUNDAI MOTOR COMPANY, Seoul (KR); Kia Corporation, Seoul (KR)

(21) Appl. No.: 17/851,539

(22) Filed: Jun. 28, 2022

(30) Foreign Application Priority Data
Oct. 8, 2021 (KR) 10-2021-0134311

(51) Int. Cl. G06F 8/65; A61G 7/018

(52) U.S. Cl. CPC G06F 8/65; A61G 7/018; A61G 2203/12; A61G 2203/16; A61G 2203/20; A61G 2203/70

(57) ABSTRACT

An apparatus for updating a controller for a mobility device includes a communication device that receives information associated with updating one or more controllers included in the mobility device, transmits the information associated with the updating to a terminal of a user or an interface of the mobility device, and receives information about an update preference of the user based on the information associated with the updating from the terminal of the user, and a management device that generates at least one of whether to update the one or more controllers or an update sequence of the one or more controllers, based on the information about the update preference.

### CROSS-REFERENCE TO RELATED APPLICATION

This application claims the benefit of priority to Korean Patent Application No. 10-2021-0134311, filed in the Korean Intellectual Property Office on Oct. 8, 2021, the entire contents of which are incorporated herein by reference.

### TECHNICAL FIELD

The present disclosure relates to an apparatus and method for updating a controller for a mobility device.

### BACKGROUND

In general, whether to update a controller included in a mobility device is determined based on a power condition or a driving state of the mobility device. For example, the controller may be updated while the mobility device is charged and may not be updated while the mobility device is discharged. In another example, the controller may be updated while the mobility device is stopped or turned off and may not be updated while the mobility device is driven.

This method uniformly determines whether to update the controller, only based on some conditions. Therefore, even when it is possible to improve user convenience by updating the controller while the mobility device is driven or discharged, the updating of the controller is restricted.

Furthermore, the conventional update method simply determines whether to update the controller and fails to reflect a user's preferences.

### SUMMARY

The present disclosure has been made to solve the above-mentioned problems occurring in the prior art while advantages achieved by the prior art are maintained intact.

An aspect of the present disclosure provides a mobility device controller update apparatus and method for generating whether to update controllers or an update sequence of the controllers based on an update preference of a user.

Another aspect of the present disclosure provides a mobility device controller update apparatus and method for generating whether to update controllers or an update sequence of the controllers by reflecting information about a product factor of update of the controllers in an update preference.

Another aspect of the present disclosure provides a mobility device controller update apparatus and method for leading a user to change information about an update preference to secure and maintain entire system safety and operation including interworking between controllers.

Another aspect of the present disclosure provides a mobility device controller update apparatus and method for changing whether to update controllers or adjusting an update sequence of the controllers to secure and maintain entire system safety and operation including interworking between controllers.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for updating a controller for a mobility device includes a communication device that receives an information associated with updating one or more controllers included in the mobility device, transmits the information associated with the updating to a terminal of a user or an interface of the mobility device, and receives information about an update preference of the user based on the information associated with the updating from the terminal of the user, and a management device that generates at least one of whether to update the one or more controllers or an update sequence of the one or more controllers, based on the information about the update preference.

In an embodiment, the information associated with the updating may include information about a product factor of the updating, and the information about the product factor of the updating may include at least one of a grade of the updating or cost of the updating.

In an embodiment, the information about the update preference may include at least one of whether to select the product factor based on the information about the product factor of the updating or an update priority.

In an embodiment, the management device may transfer information leading to change the information about the update preference to the terminal of the user through the communication device, when it is determined that it is necessary to change at least one of whether to update the one or more controllers or the update sequence of the one or more controllers, based on information about system safety and operation included in the mobility device including interworking between the one or more controllers.

In an embodiment, when it is determined that it is necessary to change whether to update the one or more controllers, based on information about system safety and operation included in the mobility device including interworking between the one or more controllers, the management device may change whether to update the one or more controllers based on the information about the system safety and operation, may transfer the changed whether to update the one or more controllers to the terminal of the user through the communication device, and may perform an update based on the changed whether to update the one or more controllers.

In an embodiment, when it is determined that it is necessary to adjust the update sequence of the one or more controllers, based on information about system safety and operation included in the mobility device including interworking between the one or more controllers, the management device may adjust the update sequence of the one or more controllers based on the information about the system safety and operation, may transfer the adjusted update sequence of the one or more controllers to the terminal of the user through the communication device, and may perform an update based on the adjusted update sequence of the one or more controllers.

In an embodiment, the one or more controllers may include at least one of a seat controller, an air bag controller, or a navigation system controller of the mobility device.

In an embodiment, the terminal of the user may include a portable terminal including a smart phone, and the interface of the mobility device may include at least one of a monitor, a touch screen, a head-up display (HUD), a cluster, or a sound system.

In an embodiment, the communication device may receive the information associated with the updating from an update providing device including a server and may transfer the information associated with the updating to the management device.

In an embodiment, when, among the one or more controllers, there is a second controller having a lower update priority than a first controller determined to perform the updating based on whether to update the one or more controllers, the management device may adjust the update priority of the second controller such that the update priority of the second controller is equal to the update priority of the first controller, based on information about system safety and operation included in the mobility device including interworking between the one or more controllers.

According to another aspect of the present disclosure, a method for updating a controller for a mobility device includes receiving, by a communication device, an information associated with updating one or more controllers included in the mobility device, transmitting, by the communication device, the information associated with the updating to a terminal of a user or an interface of the mobility device, receiving, by the communication device, information about an update preference of the user based on the information associated with the updating from the terminal of the user, and generating, by a management device, at least one of whether to update the one or more controllers or an update sequence of the one or more controllers, based on the information about the update preference.

In an embodiment, the information associated with the updating may include information about a product factor of the updating, and the information about the product factor of the updating may include at least one of a grade of the updating or cost of the updating.

In an embodiment, the information about the update preference may include at least one of whether to select the product factor based on the information about the product factor of the updating or an update priority.

In an embodiment, the method may further include transferring, by the management device, information leading to change the information about the update preference to the terminal of the user through the communication device, when it is determined that it is necessary to change at least one of whether to update the one or more controllers or the update sequence of the one or more controllers, based on information about system safety and operation included in the mobility device including interworking between the one or more controllers.

In an embodiment, the method may further include changing, by the management device, whether to update the one or more controllers based on information about system safety and operation, when it is determined that it is necessary to change whether to update the one or more controllers, based on the information about the system safety and operation included in the mobility device including interworking between the one or more controllers, transferring, by the management device, the changed whether to update the one or more controllers to the terminal of the user through the communication device, and performing, by the management device, an update based on the changed whether to update the one or more controllers.

In an embodiment, the method may further include adjusting, by the management device, the update sequence of the one or more controllers based on information about system safety and operation, when it is determined that it is necessary to adjust the update sequence of the one or more controllers, based on the information about the system safety and operation included in the mobility device including interworking between the one or more controllers, transferring, by the management device, the adjusted update sequence of the one or more controllers to the terminal of the user through the communication device, and performing, by the management device, an update based on the adjusted update sequence of the one or more controllers.

In an embodiment, the one or more controllers may include at least one of a seat controller, an air bag controller, or a navigation system controller of the mobility device.

In an embodiment, the terminal of the user may include a portable terminal including a smart phone, and the interface of the mobility device may include at least one of a monitor, a touch screen, a head-up display (HUD), a cluster, or a sound system.

In an embodiment, the method may further include receiving, by the communication device, the information associated with the updating from an update providing device including a server and transferring the information associated with the updating to the management device.

In an embodiment, the method may further include, when, among the one or more controllers, there is a second controller having a lower update priority than a first controller determined to perform the updating based on whether to update the one or more controllers, adjusting, the management device, an update priority of the second controller such that the update priority of the second controller is equal to an update priority of the first controller, based on information about system safety and operation included in the mobility device including interworking between the one or more controllers.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating an apparatus for updating a controller for a mobility device according to an embodiment of the present disclosure;

FIG. 2 is a view illustrating an apparatus for updating a controller for a mobility device according to another embodiment of the present disclosure and a flow of related information;

FIG. 3 is a view illustrating an apparatus for updating a controller for a mobility device according to another embodiment of the present disclosure, information about a product factor of update, and information about an update preference;

FIG. 4 is a view illustrating a method for updating a controller for a mobility device according to an embodiment of the present disclosure;

FIG. 5 is a view illustrating an example of leading to change information about an update preference according to an embodiment; and

FIG. 6 is a view illustrating an example of changing whether to update controllers or adjusting an update sequence of the controllers according to an embodiment.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

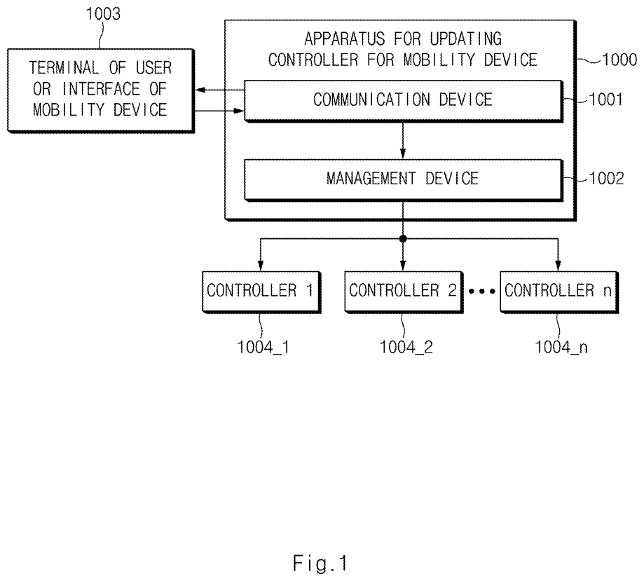

Hereinafter, embodiments of the present disclosure will be described in detail with reference to FIGS. 1 to 6.

FIG. 1 is a view illustrating an apparatus 1000 for updating a controller for a mobility device according to an embodiment of the present disclosure.

The mobility device may include a moving means that can be driven by a person or can be automatically driven and that can transport a person or a thing.

The mobility device may be driven on the ground, under the ground, on the water, in the water, or in the air.

The mobility device may include, but is not limited to, a vehicle, a motor cycle, a scooter, a robot, an electrically-powered kickboard, an electric paddle board, an electric skateboard, or an electric bike.

In particular, the power of the mobility device may be electrical energy based on a battery, but is not limited thereto.

The vehicle included in the mobility device may include an Electric Vehicle (EV), a Hybrid Electric Vehicle (HEV), a hydrogen electric vehicle, a Plug-in Hybrid Electric Vehicle (PHEV), or an internal combustion engine vehicle.

Controllers 1004_1 to 1004_n may be objects included in the mobility device and may include, but are not limited to, a seat controller, an air bag controller, a navigation system controller, or an infotainment system controller of the mobility device.

Update may include, but is not limited to, a function added or changed for the controllers 1004_1 to 1004_n, correction of contents or errors, and the like.

The apparatus 1000 for updating the controller for the mobility device may include a communication device 1001 and a management device 1002.

The apparatus 1000 for updating the controller for the mobility device may further include one or more elements not illustrated in FIG. 1.

The apparatus 1000 for updating the controller for the mobility device may be included inside or outside the mobility device described above.

The communication device 1001 may perform wired or wireless communication. The communication device 1001 may receive information associated with updating, may communicate with a terminal 1003 of a user or an interface 1003 of the mobility device, and may communicate with the management device 1002.

Specifically, the communication device 1001 may use a communication method, such as Local Interconnect Network (LIN), Controller Area Network (CAN), FlexRay Communication Bus, Media Oriented Systems Transport (MOST), Dedicated Short Range Communication (DSRC), Cellular Vehicle-to-Everything (C-V2X), Wi-Fi, Wireless Broadband (WiBro), or Worldwide Interoperability for Microwave Access (WiMax), but is not limited thereto.

The communication device 1001 may transmit information to the terminal 1003 of the user or the interface 1003 of the mobility device and may receive information from the terminal 1003 of the user or the interface 1003 of the mobility device.

The terminal 1003 of the user may include a portable terminal including a smart phone and may be located outside or inside the mobility device.

The interface 1003 of the mobility device may include not only a visual or tactile interface system, such as a monitor, a touch screen, a Head-Up Display (HUD), a cluster, or an infotainment system of the mobility device, but also a sound system, such as a voice recognition device including a microphone or a sound output device including a speaker.

The information that the communication device 1001 transmits to the terminal 1003 of the user or the interface 1003 of the mobility device may include information associated with updating a controller, and the information that the communication device 1001 receives from the terminal 1003 of the user or the interface 1003 of the mobility device may include information about an update preference of the user based on the information associated with the updating.

Specifically, the information associated with the updating may include information about one or more of the controllers 1004_1 to 1004_n to be updated, update contents, a product factor of the updating, time taken to perform the updating, an update date, whether to perform the updating based on a power condition or a driving state, whether to operate the controllers 1004_1 to 1004_n again after the updating, or energy required for the updating.

The information about the product factor of the updating may include information about one or more of a grade, cost, a period of use, or an update period of the updating.

The information about the update preference, which is received from the user based on the information associated with the updating, may include information about one or more of whether the user wants to perform the updating, an update priority, whether to select the product factor of the updating, or whether to automatically perform the updating on the corresponding controllers 1004_1 to 1004_n.

Meanwhile, the terminal 1003 of the user or the interface 1003 of the mobility device that receives the information associated with the updating from the communication device 1001 may be different from, or the same as, the terminal 1003 of the user or the interface 1003 of the mobility device that transmits the information about the update preference of the user to the communication device 1001.

The communication device 1001 may transfer the information about the update preference to the management device 1002.

The management device 1002 may generate one or more of whether to update the controllers or an update sequence of the controllers, based on the received information about the update preference.

Specifically, the management device 1002 may generate whether to update the controllers, based on one or more of the controllers 1004_1 to 1004_n to be updated, whether the user wants to perform the updating, the update priority, whether to select the product factor of the updating, or whether to automatically perform the updating on the corresponding controllers 1004_1 to 1004_n, which is included in the information about the update preference.

In particular, when receiving information on whether to automatically perform the updating on the corresponding controllers 1004_1 to 1004_n, which is included in the information about the update preference, the management device 1002 may generate whether to update the controllers, based on the information.

Specifically, the management device 1002 may generate the update sequence of the controllers, based on one or more of the controllers 1004_1 to 1004_n to be updated, whether the user wants to perform the updating, the update priority, whether to select the product factor of the updating, or whether to automatically perform the updating on the corresponding controllers 1004_1 to 1004_n, which is included in the information about the update preference.

In particular, the management device 1002 may generate the update sequence of the controllers, based on the update priority included in the information about the update preference.

Meanwhile, the update priority may be different for each of the controllers 1004_1 to 1004_n, or may be the same such that the updating is performed in parallel.

The management device 1002 may temporarily or permanently store one or more of the information about the update preference, whether to update the controllers, or the update sequence of the controllers.

The management device 1002 may transfer, to the controllers 1004_1 to 1004_n, one or more of the information on whether to update the controllers or the update sequence of the controllers.

The management device 1002 may update the controllers 1004_1 to 1004_n, based on one or more of whether to update the controllers or the update sequence of the controllers.

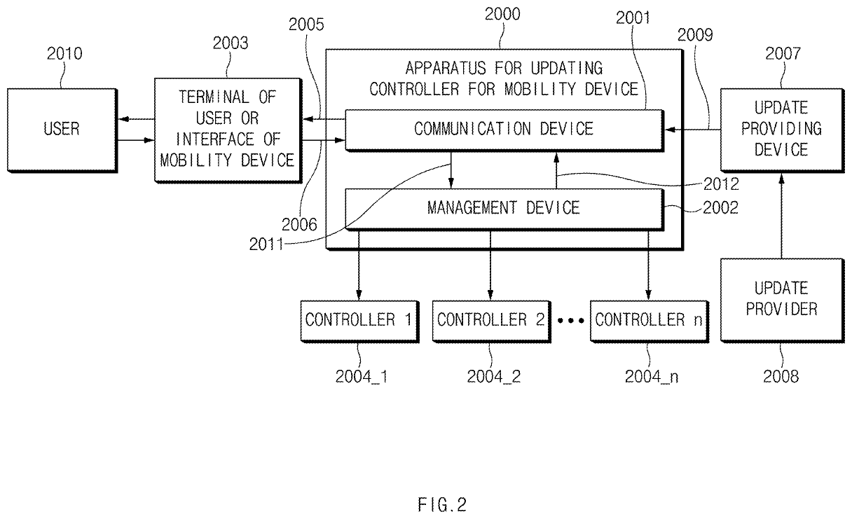

FIG. 2 is a view illustrating an apparatus 2000 for updating a controller for a mobility device according to another embodiment of the present disclosure and a flow of related information.

An update provider 2008 including a mobility device manufacturer, a mobility device part manufacturer, or a content creator may upload information associated with updating to an update providing device 2007 including a server or a smart phone.

A communication device 2001 may receive the information associated with the updating from the update providing device 2007 (operation 2009).

The communication device 2001 may transfer the information associated with the updating to a management device 2002 (operation 2011).

The communication device 2001 may transmit the information associated with the updating to a user terminal 2003 or an interface 2003 of the mobility device (operation 2005).

A user 2010 may identify the information associated with the updating through the user terminal 2003 or the interface 2003 of the mobility device and may input information about an update preference based on the information associated with the updating through the user terminal 2003 or the interface 2003 of the mobility device.

The communication device 2001 may receive the information about the update preference from the user terminal 2003 or the interface 2003 of the mobility device (operation 2006).

Meanwhile, the user terminal 2003 or the interface 2003 of the mobility that transmits the information about the update preference to the communication device 2001 may be the same as, or different from, the user terminal 2003 or the interface 2003 of the mobility that receives the information associated with the updating from the communication device 2001.

The communication device 2001 may transfer the received information about the update preference to the management device 2002 (operation 2011).

The management device 2002 may generate one or more of whether to update controllers or an update sequence of the controllers, based on the received information about the update preference.

Specifically, the management device 2002 may generate whether to update the controllers, based on one or more of controllers 2004_1 to 2004_n to be updated, whether the user wants to perform the updating, an update priority, whether to select a product factor of the updating, or whether to automatically perform the updating on the corresponding controllers 2004_1 to 2004_n, which is included in the information about the update preference.

In particular, when receiving information on whether to automatically perform the updating on the corresponding controllers 2002_1 to 2004_n, which is included in the information about the update preference, the management device 2002 may generate whether to update the controllers, based on the information.

Specifically, the management device 2002 may generate the update sequence of the controllers, based on one or more of the controllers 2004_1 to 2004_n to be updated, whether the user wants to perform the updating, the update priority, whether to select the product factor of the updating, or whether to automatically perform the updating on the corresponding controllers 2004_1 to 2004_n, which is included in the information about the update preference.

In particular, the management device 2002 may generate the update sequence of the controllers, based on the update priority included in the information about the update preference.

Meanwhile, the update priority may be different for each of the controllers 2004_1 to 2004_n, or may be the same such that the updating is performed in parallel.

The management device 2002 may update the controllers 2004_1 to 2004_n, based on one or more of whether to update the controllers or the update sequence of the controllers.

The management device 2002 may transfer information leading to change the information about the update preference to the user 2010 through the communication device 2001, when it is determined that it is necessary to change whether to update the controllers according to the update preference of the user, based on system safety and operation included in the mobility device including interworking between the controllers 2004_1 to 2004_n.

Specifically, the information leading to change the information about the update preference may be transmitted to the user terminal 2003 or the interface 2003 of the mobility device through the communication device 2001 and may be guided to the user 2010, and the user 2010 may input the information associated with the updating differently from the existing one.

The communication device 2001 may receive information about a new update preference input differently from the existing one (operation 2006) and may transfer the received information to the management device 2002 (operation 2011). Based on the received information about the new update preference, the management device 2002 may generate whether to update the controllers, or may determine whether it is necessary to change whether to update the controllers, based on the above-described system safety and operation.

Meanwhile, the management device 2002 may transfer information leading to change the information about the update preference to the user 2010 through the communication device 2001, when it is determined that it is necessary to adjust the update sequence of the controllers according to the update preference of the user, based on the above-described system safety and operation.

Specifically, the information leading to change the information about the update preference may be transmitted to the user terminal 2003 or the interface 2003 of the mobility device through the communication device 2001 and may be guided to the user 2010, and the user 2010 may input the information about the update preference differently from the existing one.

The communication device 2001 may receive information about a new update preference input differently from the existing one (operation 2006) and may transfer the received information to the management device 2002 (operation 2011). Based on the received information about the new update preference, the management device 2002 may generate whether to update the controllers, or may determine whether it is necessary to change whether to update the controllers, based on the above-described system safety and operation.

Meanwhile, the management device 2002 may not lead the user 2010 to change the information about the update preference unlike in the above-described embodiments and may change whether to update the controllers, or may adjust the update sequence of the controllers, based on the information about the system safety and operation.

Specifically, the management device 2002 may not lead the user 2010 to change the information about the update preference and may change whether to update the controllers, based on the system safety and operation, when it is determined that it is necessary to change whether to update the controllers, based on the above-described system safety and operation.

The management device 2002 may transfer whether to update the controllers to the user terminal 2003 or the interface 2003 of the mobility device through the communication device 2001.

The management device 2002 may update the controllers 2004_1 to 2004_n, based on whether to update the controllers.

Meanwhile, the management device 2002 may not lead the user 2010 to change the information about the update preference and may adjust the update sequence of the controllers based on the system safety and operation, when it is determined that it is necessary to adjust the update sequence of the controllers, based on the above-described system safety and operation.

The management device 2002 may transfer the adjusted update sequence of the controllers to the user terminal 2003 or the interface 2003 of the mobility device through the communication device 2001.

The management device 2002 may update the controllers 2004_1 to 2004_n, based on the adjusted update sequence of the controllers.

Meanwhile, the management device 2002 may transfer, to the controllers 2004_1 to 2004_n, whether to update the controllers or the update sequence of the controllers.

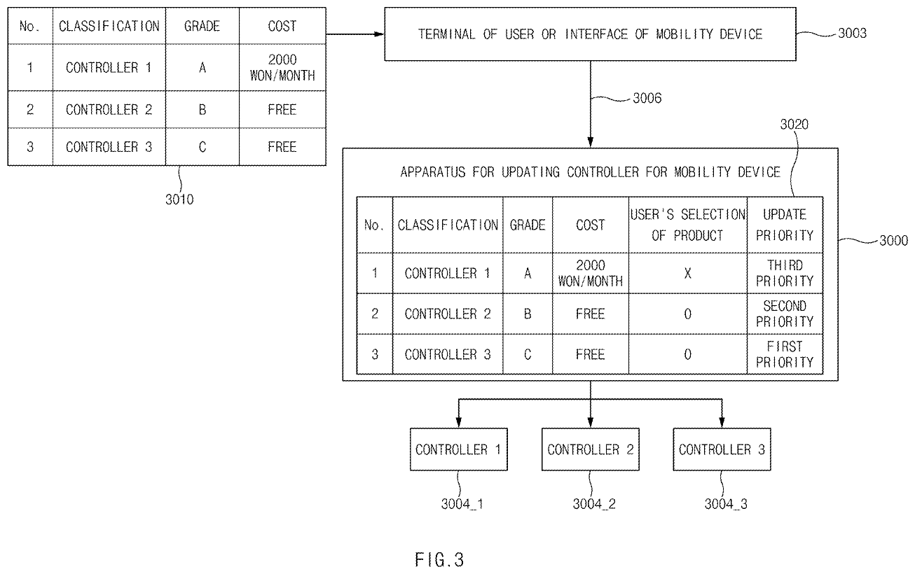

FIG. 3 is a view illustrating an apparatus 3000 for updating a controller for a mobility device according to another embodiment of the present disclosure, information 3010 about a product factor of update, and information 3020 about an update preference.

The information 3010 about the product factor of update may include one or more of controllers 3004_1 to 3004_3 to be updated, an update grade, or update cost.

The update grade may be a magnitude of utility or driving experience improvement expected to be felt by a user through the update, and may be evaluated and set by an update provider.

A user may refer to the update grade when inputting information about the update preference.

For example, the update grade may be represented as A, B, or C, but other methods may be used.

For example, the update cost may include cost according to a usage period, such as 2000 won per one month. However, the update cost may not include a usage period and may include only cost to be paid.

Furthermore, the update cost may include a case where it is free.

The information 3010 about the product factor of update may be transferred to a user terminal 3003 or an interface 3003 of the mobility device through a communication device.

A user may identify the information 3010 about the product factor of update provided through the user terminal 3003 or the interface 3003 of the mobility device and may input the information 3020 about the update preference.

The apparatus 3000 for updating the controller for the mobility device may receive the information 3020 about the update preference including the information 3010 about the product factor of update from the user terminal 3003 or the interface 3003 of the mobility device.

The information 3020 about the update preference may include one or more of the controllers to be updated, whether to select the product factor of update, or an update priority.

The apparatus 3000 for updating the controller for the mobility device may generate one or more of whether to update the controllers or an update sequence of the controllers, based on the received information 3020 about the update preference.

The apparatus 3000 for updating the controller for the mobility device may generate whether to update the controllers, based on whether to select the product factor.

For example, in the case of the controller 1 3004_1, the selection of the product factor represents that the user does not want to update the controller 1 3004_1, and therefore whether to update the controllers in which the update of the controller 1 3004_1 is not performed may be generated.

For example, in the case of the controller 2 3004_2 and the controller 3 3004_3, the selection of the product factor represents that the user wants to update the controller 2 3004_2 and the controller 3 3004_3, and therefore whether to update the controllers in which the update of the controller 2 3004_2 and the controller 3 3004_3 is performed may be generated.

Meanwhile, the apparatus 3000 may generate the update sequence of the controllers, based on the update priority.

For example, the user inputs second priority for the controller 2 3004_2 and first priority for the controller 3 3004_3, and therefore the update sequence of the controllers in which the second priority is set for the controller 2 3004_2 and the first priority is set for the controller 3 3004_3 may be generated.

The apparatus 3000 for updating the controller for the mobility device may update the controllers 3004_2 and 3004_3, based on one or more of whether to update the controllers or the update sequence of the controllers.

The apparatus 3000 for updating the controller for the mobility device may transfer, to the controllers 3004_2 and 3004_3, one or more of whether to update the controllers or the update sequence of the controllers.

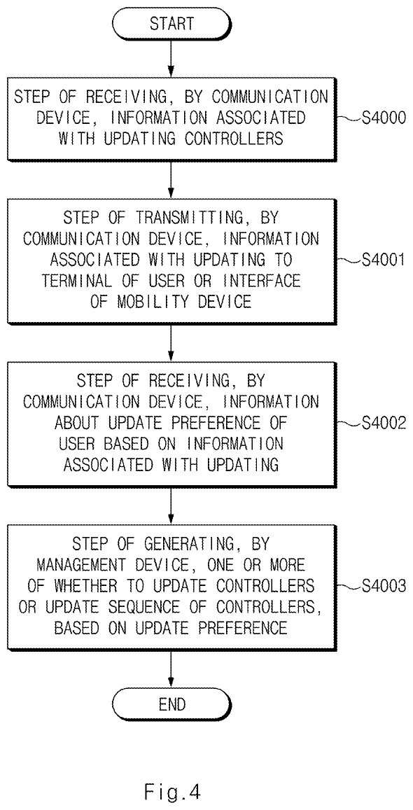

FIG. 4 is a view illustrating a method for updating a controller for a mobility device according to an embodiment of the present disclosure.

The apparatuses 1000, 2000, and 3000 described above with reference to FIGS. 1 to 3 may perform the method to be described with reference to FIG. 4.

The method for updating the controller for the mobility device may include a step of receiving, by a communication device, information associated with updating controllers (S4000), a step of transmitting, by the communication device, the information associated with the updating to a terminal of a user or an interface of the mobility device (S4001), a step of receiving, by the communication device, information about an update preference of the user based on the information associated with the updating (S4002), and a step of generating, by a management device, one or more of whether to update the controllers or an update sequence of the controllers, based on the information about the update preference (S4003).

In step S4000, the information associated with the updating may include information about one or more of the controllers to be updated, update contents, a product factor of the updating, time taken to perform the updating, an update date, whether to perform the updating based on a power condition or a driving state, whether to operate the controllers again after the updating, or energy required for the updating.

The information about the product factor of the updating may include information about one or more of a grade, cost, a period of use, or an update period of the updating.

In step S4001, the information associated with the updating may be transmitted to the terminal of the user which may include a portable terminal including a smart phone and which may be located outside or inside the mobility device.

In step S4001, the information associated with the updating may be alternatively transmitted to the interface of the mobility device which may include not only a visual or tactile interface system, such as a monitor, a touch screen, a Head-Up Display (HUD), a cluster, or an infotainment system of the mobility device, but also a sound system, such as a voice recognition device including a microphone or a sound output device including a speaker.

In step S4002, the information about the update preference, which is received from the user based on the information associated with the updating, may include information about one or more of the controllers to be updated, whether the user wants to perform the updating, an update priority, whether to select the product factor of the updating, or whether to automatically perform the updating on the corresponding controllers.

In step S4003, in the method for updating the controller for the mobility device, the management device may generate one or more of whether to update the controllers or the update sequence of the controllers, based on the information about the update preference.

Specifically, in the method for updating the controller for the mobility device, the management device may generate whether to update the controllers, based on one or more of the controllers to be updated, whether the user wants to perform the updating, an update priority, whether to select a product factor of the updating, or whether to automatically perform the updating on the corresponding controllers, which is included in the information about the update preference.

In particular, in the method for updating the controller for the mobility device, when receiving information on whether to automatically perform the updating on the corresponding controllers, which is included in the information about the update preference, the management device may generate whether to update the controllers, based on the information.

Specifically, in the method for updating the controller for the mobility device, the management device may generate the update sequence of the controllers, based on one or more of the controllers to be updated, whether the user wants to perform the updating, the update priority, whether to select a product factor of the updating, or whether to automatically perform the updating on the corresponding controllers, which is included in the information about the update preference.

In particular, the management device may generate the update sequence of the controllers, based on the update priority included in the information about the update preference.

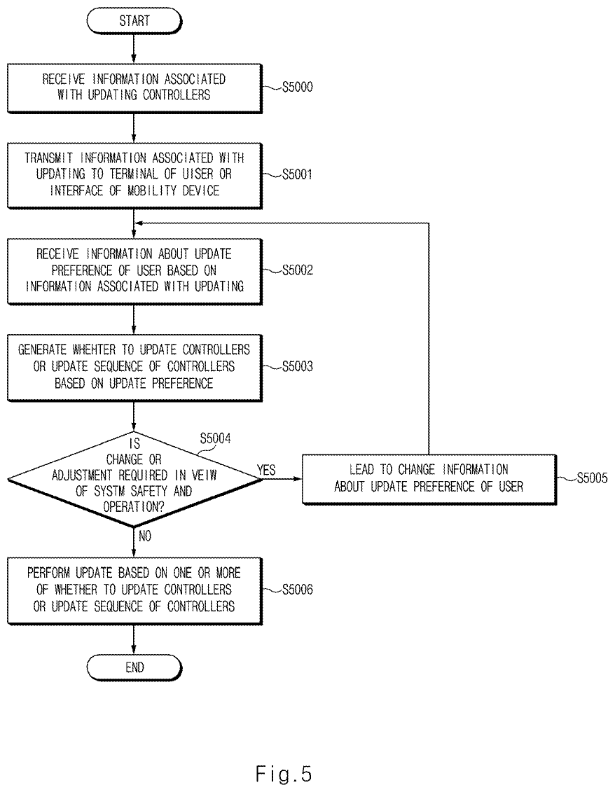

FIG. 5 is a view illustrating an example of leading to change information about an update preference according to an embodiment.

The apparatuses 1000, 2000, and 3000 described above with reference to FIGS. 1 to 3 may perform a method that will be described below with reference to FIG. 5.

A method for updating a controller for a mobility device may include a step of receiving, by a communication device, information associated with updating one or more controllers included in the mobility device (S5000), a step of transmitting, by the communication device, the information associated with the updating to a terminal of a user or an interface of the mobility device (S5001), a step of receiving, by the communication device, information about an update preference of the user based on the information associated with the updating from the user (S5002), and a step of generating, by a management device, information about one or more of whether to update the controllers or an update sequence of the controllers, based on the information about the update preference (S5003).

In step S5000, the information associated with updating the controllers may include information about one or more of the controllers to be updated, update contents, a product factor of the updating, time taken to perform the updating, an update date, whether to perform the updating based on a power condition or a driving state, whether to operate the controllers again after the updating, or energy required for the updating.

In step S5001, the information associated with the updating may be transmitted to the terminal of the user which may include a portable terminal including a smart phone and which may be located outside or inside the mobility device.

In step S5001, the information associated with the updating may be alternatively transmitted to the interface of the mobility device which may include not only a visual or tactile interface system, such as a monitor, a touch screen, a Head-Up Display (HUD), a cluster, or an infotainment system of the mobility device, but also a sound system, such as a voice recognition device including a microphone or a sound output device including a speaker.

In step S5002, the information about the update preference, which is received from the user based on the information associated with the updating, may include information about one or more of the controllers to be updated, whether the user wants to perform the updating, an update priority, whether to select the product factor of the updating, or whether to automatically perform the updating on the corresponding controllers.

In the method for updating the controller for the mobility device, the management device may generate one or more of whether to update the controllers or the update sequence of the controllers, based on the information about the update preference (S5003).

In the method for updating the controller for the mobility device, the management device may perform update based on one or more of whether to update the controllers or the update sequence of the controllers (S5006), when it is determined that it is not necessary to change or adjust whether to update the controllers and the update sequence of the controllers, based on system safety and operation included in the mobility device (NO of S5004).

The method for updating the controller for the mobility device may further include a step of transferring, by the management device, information leading to change the information about the update preference to the user through the communication device (S5005), when it is determined that it is necessary to change or adjust one or more of whether to update the controllers or the update sequence of the controllers, based on information about the system safety and operation included in the mobility device (YES of S5004).

The user who receives the information leading to change the information about the update preference may input information about an update preference differently from the existing one.

The method for updating the controller for the mobility device may receive the information about the update preference that the user inputs differently from the existing one.

The method for updating the controller for the mobility device may generate whether to update the controllers or the update sequence of the controllers, based on the information about the update preference that the user inputs differently from the existing one (S5003).

The method for updating the controller for the mobility device may perform update based on one or more of whether to update the controllers or the update sequence of the controllers (S5006), when it is determined that it is not necessary to change or adjust whether to update the controllers or the update sequence of the controllers, which is generated based on the information about the update preference that the user inputs differently from the existing one, in view of the system safety and operation included in the mobility device (NO of S5004). Here, whether to update the controllers or the update sequence of the controllers may include that generated based on the information about the update preference that the user inputs differently from the existing one.

Meanwhile, the method for updating the controller for the mobility device may transfer information leading to change the information about the update preference to the user through the communication device again (S5005), when it is determined that it is necessary to change or adjust whether to update the controllers or the update sequence of the controllers, which is generated based on the information about the update preference that the user inputs differently from the existing one, in view of the system safety and operation included in the mobility device (YES of S5004).

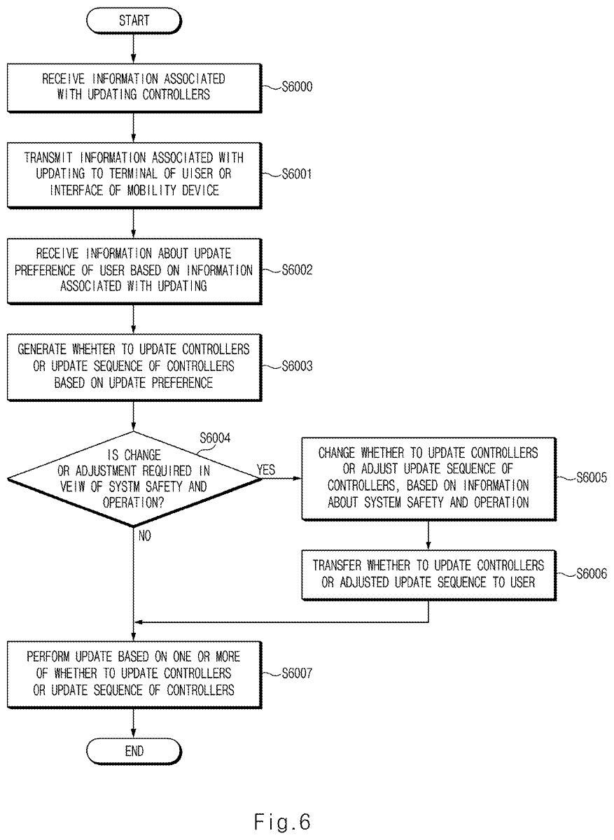

FIG. 6 illustrates an example of changing whether to update controllers or adjusting an update sequence of the controllers according to an embodiment.

The apparatuses 1000, 2000, and 3000 described above with reference to FIGS. 1 to 3 may perform a method that will be described below with reference to FIG. 6.

A method for updating a controller for a mobility device may include a step of receiving, by a communication device, information associated with updating one or more controllers included in the mobility device (S6000), a step of transmitting, by the communication device, the information associated with the updating to a terminal of a user or an interface of the mobility device (S6001), a step of receiving, by the communication device, information about an update preference of the user based on the information associated with the updating from the user (S6002), and a step of generating, by a management device, information about one or more of whether to update the controllers or an update sequence of the controllers, based on the information about the update preference (S6003).

In step S6000, the information associated with updating the controllers may include information about one or more of the controllers to be updated, update contents, a product factor of the updating, time taken to perform the updating, an update date, whether to perform the updating based on a power condition or a driving state, whether to operate the controllers again after the updating, or energy required for the updating.

In step S6001, the information associated with the updating may be transmitted to the terminal of the user which may include a portable terminal including a smart phone and which may be located outside or inside the mobility device.

In step S6001, the information associated with the updating may be alternatively transmitted to the interface of the mobility device which may include not only a visual or tactile interface system, such as a monitor, a touch screen, a Head-Up Display (HUD), a cluster, or an infotainment system of the mobility device, but also a sound system, such as a voice recognition device including a microphone or a sound output device including a speaker.

In step S6002, the information about the update preference, which is received from the user based on the information associated with the updating, may include information about one or more of the controllers to be updated, whether the user wants to perform the updating, an update priority, whether to select the product factor of the updating, or whether to automatically perform the updating on the corresponding controllers.

In the method for updating the controller for the mobility device, the management device may generate one or more of whether to update the controllers or the update sequence of the controllers, based on the information about the update preference (S6003).

In the method for updating the controller for the mobility device, the management device may perform update based on one or more of whether to update the controllers or the update sequence of the controllers (S6007), when it is determined that it is not necessary to change whether to update the controllers and adjust the update sequence of the controllers, based on system safety and operation included in the mobility device (NO of S6004).

The method for updating the controller for the mobility device may further include a step of changing, by the management device, whether to update the controllers based on the system safety and operation (S6005) and a step of transferring, by the management device, whether to update the controllers to the user through the communication device (S6006), when it is determined that it is necessary to change whether to update the controllers, based on the system safety and operation included in the mobility device (YES of S6004).

The method for updating the controller for the mobility device may further include a step of adjusting, by the management device, the update sequence of the controllers based on the system safety and operation (S6005) and a step of transferring, by the management device, the update sequence of the controllers to the user through the communication device (S6006), when it is determined that it is necessary to adjust the update sequence of the controllers, based on the system safety and operation included in the mobility device (YES of S6004).

The method for updating the controller for mobility device may perform update based on one or more of whether to update the controllers or the update sequence of the controllers (S6007). Here, whether to update controllers may include whether to update the controllers that is changed based on the system safety and operation, and the update sequence of the controllers may include the update sequence adjusted based on the system safety and operation.

The above-described communication device may include communication circuitry, communication electronic components, and/or a processor, and may be configured to perform the communication operations.

The operations of the methods or algorithm described in connection with the embodiments disclosed herein may be embodied in hardware or a software module executed by a processor or in a combination thereof. The software module may reside on a non-transitory computer-readable storage medium (i.e., a memory and/or a storage) such as a RAM, a flash memory, a ROM, an EPROM, an EEPROM, a register, a hard disk, a removable disk, and a CD-ROM. In one example, the above-described apparatus for updating a controller for a mobility device may include a processor which is configured to perform the above-described operations when executing the software module stored in the storage medium. In one example, the above-described management device may include a processor which is configured to perform the corresponding operations when executing the software module stored in the storage medium. In one example, the above-described communication device may include a processor which is configured to perform the corresponding operations when executing the software module stored in the storage medium.

An embodiment of the present may provide a mobility device controller update apparatus and method for generating whether to update controllers or an update sequence of the controllers based on an update preference of a user.

Another embodiment of the present disclosure may provide a mobility device controller update apparatus and method for generating whether to update controllers or an update sequence of the controllers by reflecting information about a product factor of update of the controllers in an update preference.

Another embodiment of the present disclosure may provide a mobility device controller update apparatus and method for leading a user to change information about an update preference to secure and maintain entire system safety and operation including interworking between controllers.

Another embodiment of the present disclosure may provide a mobility device controller update apparatus and method for changing whether to update controllers or adjusting an update sequence of the controllers to secure and maintain entire system safety and operation including interworking between controllers.

In addition, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for updating a controller for a mobility device, the apparatus comprising:
a communication device configured to receive an information associated with updating one or more controllers included in the mobility device, transmit the information associated with the updating to a terminal of a user or an interface of the mobility device, and receive information about an update preference of the user based on the information associated with the updating from the terminal of the user; and
a management device configured to generate at least one of whether to update the one or more controllers or an update sequence of the one or more controllers, based on the information about the update preference.

2. The apparatus of claim 1, wherein the information associated with the updating includes information about a product factor of the updating, and
wherein the information about the product factor of the updating includes at least one of a grade of the updating or cost of the updating.

3. The apparatus of claim 2, wherein the information about the update preference includes at least one of whether to select the product factor based on the information about the product factor of the updating or an update priority.

4. The apparatus of claim 1, wherein the management device transfers information leading to change the information about the update preference to the terminal of the user through the communication device, when it is determined that it is necessary to change at least one of whether to update the one or more controllers or the update sequence of the one or more controllers, based on information about system safety and operation included in the mobility device including interworking between the one or more controllers.

5. The apparatus of claim 1, wherein when it is determined that it is necessary to change whether to update the one or more controllers, based on information about system safety and operation included in the mobility device including interworking between the one or more controllers, the management device changes whether to update the one or more controllers based on the information about the system safety and operation, transfers the changed whether to update the one or more controllers to the terminal of the user through the communication device, and performs an update based on the changed whether to update the one or more controllers.

6. The apparatus of claim 1, wherein when it is determined that it is necessary to adjust the update sequence of the one or more controllers, based on information about system safety and operation included in the mobility device including interworking between the one or more controllers, the management device adjusts the update sequence of the one or more controllers based on the information about the system safety and operation, transfers the adjusted update sequence of the one or more controllers to the terminal of the user through the communication device, and performs an update based on the adjusted update sequence of the one or more controllers.

7. The apparatus of claim 1, wherein the one or more controllers include at least one of a seat controller, an air bag controller, or a navigation system controller of the mobility device.

8. The apparatus of claim 1, wherein the terminal of the user includes a portable terminal including a smart phone, and
wherein the interface of the mobility device includes at least one of a monitor, a touch screen, a head-up display (HUD), a cluster, or a sound system.

9. The apparatus of claim 1, wherein the communication device receives the information associated with the updating from an update providing device including a server and transfers the information associated with the updating to the management device.

10. The apparatus of claim 1, wherein when, among the one or more controllers, there is a second controller having a lower update priority than a first controller determined to perform the updating based on whether to update the one or more controllers, the management device adjusts the update priority of the second controller such that the update priority of the second controller is equal to the update priority of the first controller, based on information about system safety and operation included in the mobility device including interworking between the one or more controllers.

11. A method for updating a controller for a mobility device, the method comprising:
receiving, by a communication device, an information associated with updating one or more controllers included in the mobility device;
transmitting, by the communication device, the information associated with the updating to a terminal of a user or an interface of the mobility device;
receiving, by the communication device, information about an update preference of the user based on the information associated with the updating from the terminal of the user; and
generating, by a management device, at least one of whether to update the one or more controllers or an update sequence of the one or more controllers, based on the information about the update preference.

12. The method of claim 11, wherein the information associated with the updating includes information about a product factor of the updating, and
wherein the information about the product factor of the updating includes at least one of a grade of the updating or cost of the updating.

13. The method of claim 12, wherein the information about the update preference includes at least one of whether to select the product factor based on the information about the product factor of the updating or an update priority.

14. The method of claim 11, further comprising:
transferring, by the management device, information leading to change the information about the update preference to the terminal of the user through the communication device, when it is determined that it is necessary to change at least one of whether to update the one or more controllers or the update sequence of the one or more controllers, based on information about system safety and operation included in the mobility device including interworking between the one or more controllers.

15. The method of claim 11, further comprising:
changing, by the management device, whether to update the one or more controllers based on information about system safety and operation, when it is determined that it is necessary to change whether to update the one or more controllers, based on the information about the system safety and operation included in the mobility device including interworking between the one or more controllers;
transferring, by the management device, the changed whether to update the one or more controllers to the terminal of the user through the communication device, and
performing, by the management device, an update based on the changed whether to update the one or more controllers.

16. The method of claim 11, further comprising:
adjusting, by the management device, the update sequence of the one or more controllers based on information about system safety and operation, when it is determined that it is necessary to adjust the update sequence of the one or more controllers, based on the information about the system safety and operation included in the mobility device including interworking between the one or more controllers;
transferring, by the management device, the adjusted update sequence of the one or more controllers to the terminal of the user through the communication device; and
performing, by the management device, an update based on the adjusted update sequence of the one or more controllers.

17. The method of claim 11, wherein the one or more controllers include at least one of a seat controller, an air bag controller, or a navigation system controller of the mobility device.

18. The method of claim 11, wherein the terminal of the user includes a portable terminal including a smart phone, and
wherein the interface of the mobility device includes at least one of a monitor, a touch screen, a head-up display (HUD), a cluster, or a sound system.

19. The method of claim 11, further comprising:
receiving, by the communication device, the information associated with the updating from an update providing device including a server and transferring the information associated with the updating to the management device.

20. The method of claim 11, further comprising:
when, among the one or more controllers, there is a second controller having a lower update priority than a first controller determined to perform the updating based on whether to update the one or more controllers, adjusting, the management device, an update priority of the second controller such that the update priority of the second controller is equal to an update priority of the first controller, based on information about system safety and operation included in the mobility device including interworking between the one or more controllers.
